(19) United States
(12) Patent Application Publication
(10) Pub. No.: US 2022/0094778 A1
(43) Pub. Date: Mar. 24, 2022

(54) SYSTEM AND METHOD FOR PROVIDING CONTACTLESS CONTROL OF HARDWARE

(71) Applicant: Honda Motor Co., Ltd., Tokyo (JP)

(72) Inventor: Rahul Khanna, Mountain View, CA (US)

(21) Appl. No.: 17/026,130

(22) Filed: Sep. 18, 2020

(51) Int. Cl. H04M 1/725; G06K 7/14; G06K 7/10; G06F 21/36; G06F 21/44; G08C 17/02

(52) U.S. Cl. CPC H04M 1/72533; G06K 7/1417; G08C 17/02; G06F 21/36; G06F 21/445; G06K 7/10386

(57) ABSTRACT

A system and method for providing contactless control of hardware that includes receiving an image of a digitally encrypted code that is associated with the hardware and presenting a contactless control panel user interface on a portable device that includes a graphical representation of at least one physical control panel of the hardware. The system and method also include communicating the at least one user input provided upon the contactless control panel user interface to the hardware through near field communication (NFC communication) between the portable device and the hardware. The system and method further include controlling the hardware to execute at least one function based on the at least one user input received by the hardware through the NFC communication.

### BACKGROUND

Many publically accessible areas include hardware that require numerous individuals to physically touch buttons, screens, and/or accessories to provide various inputs. For example, bank ATMs, elevators, vending machines, ticketing kiosks, pedestrian cross-walk lighting, and the like mainly require users to physically touch hardware to complete respective functions. However, requiring physical interaction with such hardware may pose a risk of numerous individuals contacting heavily used touch points which may perpetuate a spread of germs that may be associated. In some cases, such hardware that requires physical contact to provide inputs may become a hurdle against countermeasures to prevent the spread of with the spread of viral and/or bacterial infection amongst individuals.

### BRIEF DESCRIPTION

According to one aspect, a computer-implemented method for providing contactless control of hardware that includes receiving an image of a digitally encrypted code that is associated with the hardware and presenting a contactless control panel user interface on a portable device that includes a graphical representation of at least one physical control panel of the hardware. The contactless control panel user interface enables at least one input to be provided to the hardware without physical user contact with the at least one physical control panel of the hardware. The computer-implemented method also includes communicating the at least one user input provided upon the contactless control panel user interface to the hardware through near field communication (NFC communication) between the portable device and the hardware. The computer-implemented method further includes controlling the hardware to execute at least one function based on the at least one user input received by the hardware through the NFC communication.

According to another aspect, a system for providing contactless control of hardware that includes a memory storing instructions when executed by a processor cause the processor to receive an image of a digitally encrypted code that is associated with the hardware and present a contactless control panel user interface on a portable device that includes a graphical representation of at least one physical control panel of the hardware. The contactless control panel user interface enables at least one input to be provided to the hardware without physical user contact with the at least one physical control panel of the hardware. The instructions also cause the processor to communicate the at least one user input provided upon the contactless control panel user interface to the hardware through near field communication (NFC communication) between the portable device and the hardware. The instructions further cause the processor to control the hardware to execute at least one function based on the at least one user input received by the hardware through the NFC communication.

According to yet another aspect, a non-transitory computer readable storage medium storing instructions that when executed by a computer, which includes a processor performs a method that includes receiving an image of a digitally encrypted code that is associated with the hardware and presenting a contactless control panel user interface on a portable device that includes a graphical representation of at least one physical control panel of the hardware. The contactless control panel user interface enables at least one input to be provided to the hardware without physical user contact with the at least one physical control panel of the hardware. The method also includes communicating the at least one user input provided upon the contactless control panel user interface to the hardware through near field communication (NFC communication) between the portable device and the hardware. The method further includes controlling the hardware to execute at least one function based on the at least one user input received by the hardware through the NFC communication.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, can be best understood by reference to the following detailed description of illustrative embodiments when read in conjunction with the accompanying drawings, wherein:

FIG. 1 is a schematic view of an exemplary operating environment of a system for providing contactless control of hardware according to an exemplary embodiment of the present disclosure;

FIG. 2 is an illustrative example of placing of a portable device within a predetermined proximity range of a NFC tag associated with the hardware according to an exemplary embodiment of the present disclosure;

FIG. 3A is an illustrative example of a physical control panel of hardware that is configured as an automated teller machine and a contactless control panel user interface that includes a graphic representation of the physical control panel according to an exemplary embodiment of the present disclosure;

FIG. 3B is illustrative example of a physical control panel of hardware that is configured as an elevator and a contactless control panel user interface that includes a graphic representation of the physical control panel according to an exemplary embodiment of the present disclosure;

FIG. 4 is a schematic view of a plurality of modules of the contactless control application that may execute computer-implemented instructions for providing contactless control of the hardware according to an exemplary embodiment of the present disclosure;

FIG. 5 is a process flow diagram of a method for presenting the control panel user interface with a graphical representation of the one or more physical control panels of the hardware according to an exemplary embodiment of the present disclosure;

FIG. 6 is a process flow diagram of a method for communicating input data and hardware data through the NFC communication protocol according to an exemplary embodiment of the present disclosure;

FIG. 7 is a process flow diagram of a method for providing contactless control of hardware according to an exemplary embodiment of the present disclosure; and

FIG. 8 is a process flow diagram of a method for providing contactless control of hardware according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,’ as used herein, refers to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a hardware bus that interconnects components of a hardware using protocols such as Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device” as used herein can include devices for controlling different hardware features which are include various hardware components, systems, and subsystems. The term “input device” includes, but it not limited to: push buttons, rotary knobs, touch screens, and the like. The term “input device” additionally includes graphical input controls that take place within a user interface which can be displayed by various types of mechanisms such as software and hardware based controls, interfaces, or plug and play devices.

A “memory,” as used herein can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module”, as used herein, includes, but is not limited to, hardware, firmware, software in execution on a machine, and/or combinations of each to perform a function(s) or an action(s), and/or to cause a function or action from another module, method, and/or system. A module can include a software controlled microprocessor, a discrete logic circuit, an analog circuit, a digital circuit, a programmed logic device, a memory device containing executing instructions, and so on.

An “operable connection,” as used herein can include a connection by which entities are “operably connected”, is one in which signals, physical communications, and/or logical communications can be sent and/or received. An operable connection can include a physical interface, a data interface and/or an electrical interface.

An “output device” as used herein can include devices that can derive from hardware components, systems, subsystems, and electronic devices. The term “output devices” includes, but is not limited to: display devices, and other devices for outputting information and functions.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

### I. System Overview

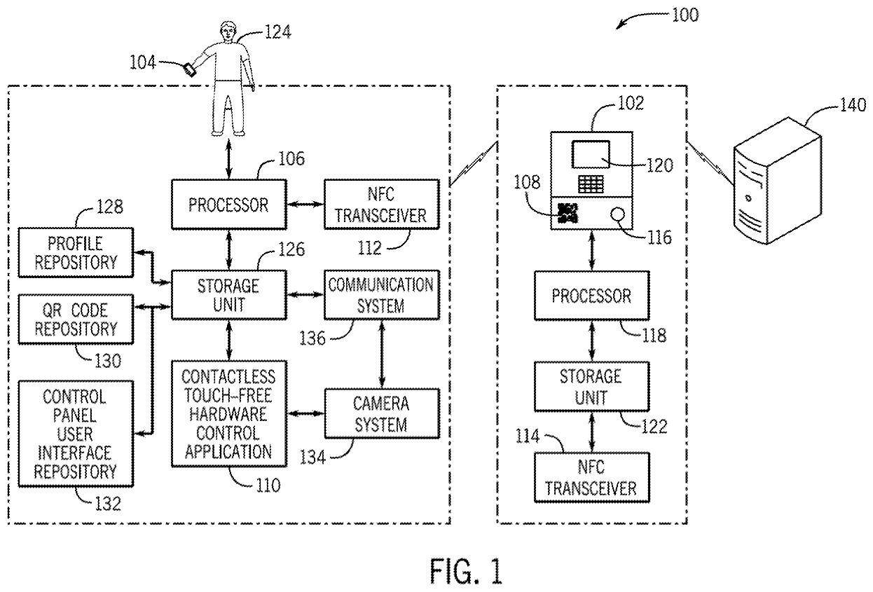

Referring now to the drawings, wherein the showings are for purposes of illustrating one or more exemplary embodiments and not for purposes of limiting the same, FIG. 1 is a schematic view of an exemplary operating environment of a system 100 for providing contactless control of hardware 102 according to an exemplary embodiment of the present disclosure. The components of the system 100, as well as the components of other systems, hardware architectures and software architectures discussed herein, may be combined, omitted or organized into different architecture for various embodiments. However, the exemplary embodiments discussed herein focus on the system 100 as illustrated in FIG. 1, with corresponding system components, and related methods.

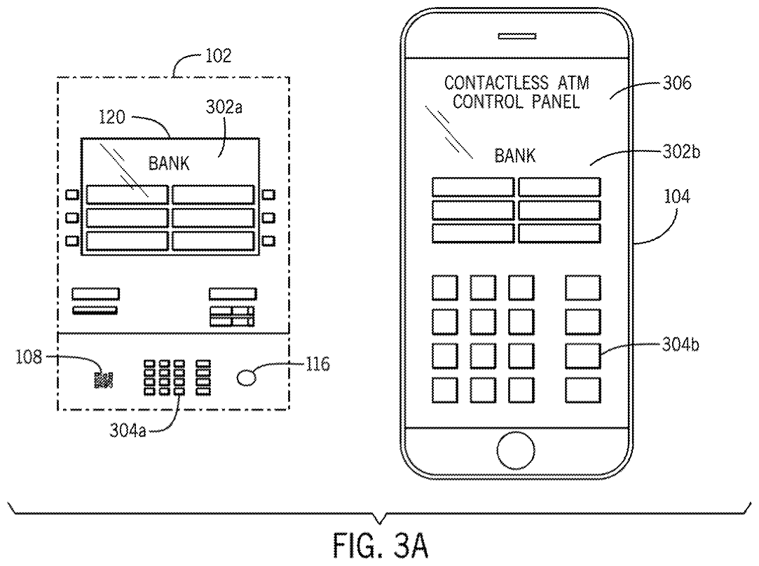

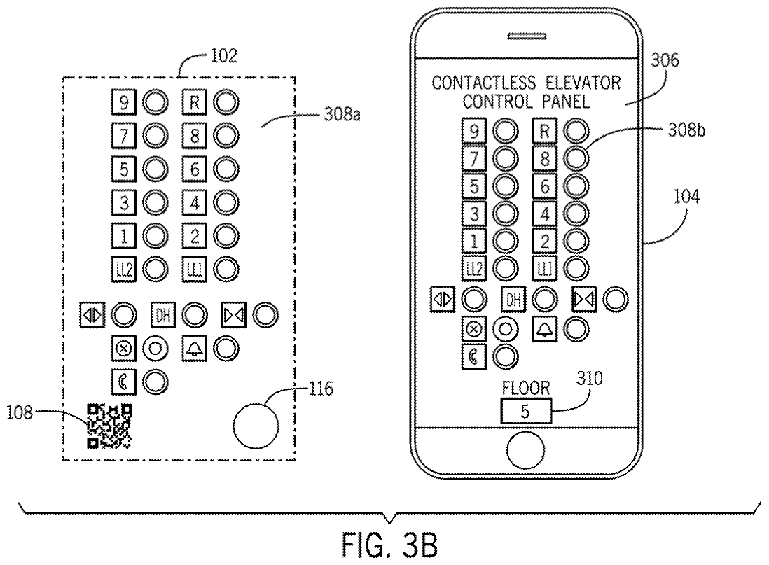

As shown in FIG. 1, the hardware 102 may be configured as an accessible electronic device such as an automated teller machine (ATM) that may perform one or more particular functions based on user touch inputs that may be provided upon one or more physically accessible control panels (physical control panels) of the hardware 102 (examples shown in FIG. 3A and FIG. 3B). The one or physical control panels of the hardware 102 may respectively include physical input means that may be configured as input buttons, input keys of a keypad, input icons of a user input user interface screen, and the like that allow a user 124 to physically provide inputs to the hardware 102. In alternate embodiments, the hardware 102 may be configured in various additional electronic device formats and/or form factors including, but not limited to, an elevator, a vending machine, a ticketing kiosk (e.g., airport kiosk, train station kiosk, parking garage kiosk), a pedestrian cross-walk lighting switch, and the like.

Under normal operating conditions, the hardware 102 mainly requires the user 124 to physically touch one or more portions of the hardware 102 that include the physical input means of the one or more physical control panels to provide one or more inputs to enable the hardware 102 to perform one or more functions (e.g., deposit/withdraw cash, input request to travel to a particular floor, receive boarding pass, receive ticket, input a request to cross a pedestrian cross-walk). For example, physical inputs may be provided to the hardware 102 configured as an ATM through a physical control panel that is configured as a keypad that requires the user to touch input physical input means configured as keypad keys to enable the hardware 102 to perform one or more particular banking related functions.

As discussed in more detail below, the hardware 102 may be configured to communicate with a portable device 104 that may be used by the user 124 through a near-field communications (NFC) communication protocol (e.g., ISO 13157). In an exemplary embodiment, the portable device 104 may include a plurality of components that may be operably controlled by a processor 106. The processor 106 may be configured to include a memory (not shown) that is configured to store instructions that are executed by the processor 106 to execute a contactless touch-free hardware control application (contactless control application) 110.

As discussed below, the hardware 102 may be configured to include and/or present a quick response code (QR code) 108 that may be scanned by the portable device 104 based on a captured image of the QR code 108. The scanning of the QR code 108 may enable the contactless control application 110 to present a contactless control panel user interface that is associated with one or more physical control panels of the hardware 102. In an exemplary embodiment, the contactless control panel user interface may include a graphical representation of each respective physical control panel of the hardware 102. Each graphical representation of the control panel user interface replicates the layout of the physical input means that are included as part of the one or more physical control panels of the hardware 102.

The contactless control application 110 may allow the user 124 to utilize the contactless control panel user interface to provide contactless inputs that are provided to the hardware 102 without physically touching any of the physical input means of the hardware 102. In other words, the user 124 may utilize the portable device 104 to provide contactless inputs to the hardware 102 to enable the hardware 102 to perform one or more functions without requiring the user 124 to physically touch input the physical input means of the one or more physical control panels of the hardware 102. The functionality of the contactless control application 110 accordingly enables the user 124 to avoid contact with publically accessible touch points while utilizing the functionality of the hardware 102.

The contactless control application 110 may utilize bi-directional NFC communication between the hardware 102 and the portable device 104 through a NFC transceiver 112 of the portable device 104 and a NFC transceiver 114 of the hardware 102 that is operably connected to an NFC tag 116 of the hardware 102. Such bi-directional NFC communication may facilitate contactless control of the hardware 102 through user inputs to one or more touch input icons that may be provided on the contactless control panel user interface presented through the portable device 104. The bi-directional NFC communication may facilitate the communication of hardware data that is associated with messages, status updates, and/or additional customized input requests (e.g., ATM card information, PIN number, security credentials) that may be communicated from the hardware 102 to the portable device 104 to be presented to the user 124 through the contactless control panel user interface.

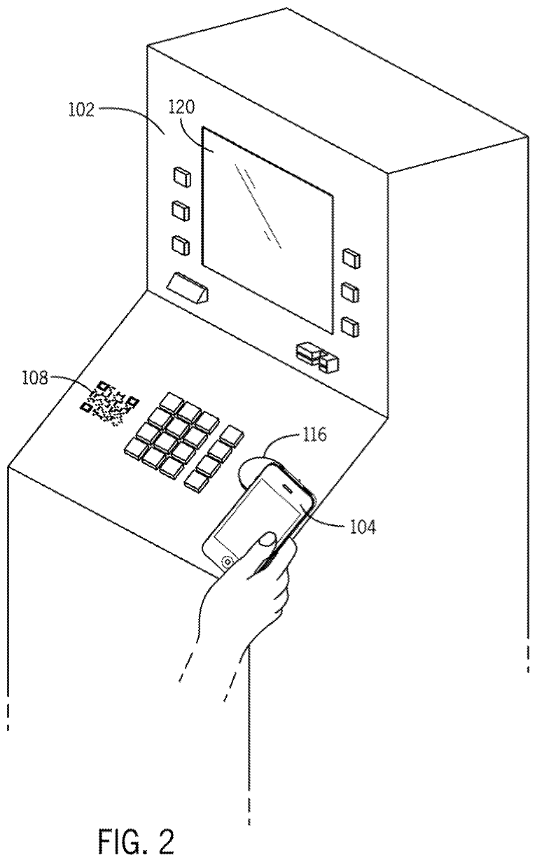

As represented in an illustrative example shown in FIG. 2, a NFC handshake may occur between the portable device 104 and the hardware 102 to commence the exchange of NFC communication signals between the NFC transceiver 112 disposed within the portable device 104 and the NFC transceiver 114 disposed within the hardware 102 based on a placement of the portable device 104 within a predetermined proximity range (e.g., 0-4 inches) from the NFC tag 116 that may be disposed upon the hardware 102 or placed at one or more locations (e.g., near the hardware 102). As represented in the illustrative example of FIG. 2, the portable device 104 may be held within four inches of the NFC tag 116 disposed upon the hardware 102 to initiate the NFC handshake and the exchange of the NFC communication signals between the hardware 102 and the portable device 104.

As discussed in more detail below, the bi-directional NFC communication of data may be utilized to enable the user 124 to provide contactless inputs to the hardware 102 without physically touching the hardware 102. The bi-directional NFC communication of data may be also be utilized to communicate hardware data to the user 124 that is associated with messages, status updates, and/or additional customized input requests that may be communicated from the hardware 102 to the portable device 104 to be presented through the contactless control panel user interface. Accordingly, the contactless control application 110 does not require physical electrical contact to be established between the portable device 104 and the NFC tag 116 such that neither the user 124 nor the portable device 104 used by the user 124 are required to physically contact any portion of the hardware 102 in order for the hardware 102 to execute one or more functions and/or to provide hardware data to the user 124.

With respect to the QR code 108 of the hardware 102, the QR code 108 may be configured as a digitally encrypted code that is provided as a physical QR code tag that is disposed upon the hardware 102 to be scanned by the user 124. Additionally or alternatively, the QR code 108 may be configured as a digitally encrypted code that is provided as a graphically generated QR code that is presented to the user 124 in a graphical manner (as described below). In one embodiment, upon scanning of the QR code 108 by the user 124 using the portable device 104 to capture an image of QR code 108, the contactless control application 110 may be configured to identify that the user 124 is utilizing the contactless control application 110 to complete one or more functions of the hardware 102. The contactless control application 110 may thereby be configured to identify the hardware 102 and determine configurations of one or more associated physical control panels of the hardware 102. The configurations of the one or more physical control panels of the hardware 102 may include a description of the type of physical input means that are included as part of the one or more physical control panels of the hardware 102 and the respective functionality of each of the physical input means with respect to the execution of one or more functions of the hardware 102.

As discussed in more detail below, upon identifying the user's utilization of the application 110 to complete one or more functions of the hardware 102 and determining the configurations of one or more physical control panels of the hardware 102, the contactless control application 110 may be configured to retrieve and present the contactless control panel user interface that includes one or more graphical representations of one or more of the respective physical control panels of the hardware 102. The one or more graphical representations presented upon the contactless control panel user interface may replicate a layout and functionality of each of the physical input means of the respective physical control panels of the hardware 102.

As shown in the illustrative example of FIG. 3A, the physical control panel 302a is configured as a touch screen interface of the hardware 102 that is configured as an ATM. The touch screen interface includes physical input means that are configured as touch input icons and associated physical input buttons. Upon determination of the configuration of the physical control panel 302a of the hardware 102 that includes a touch screen user interface, the contactless control application 110 may be configured to present a graphical representation 302b of the physical control panel 302a upon the contactless control panel user interface 306. Additionally, upon determination of the configuration of the physical control panel 304a of the hardware 102 that includes physical input means that are configured as an alpha-numeric and operational keys of a keypad, the contactless control application 110 may be configured to retrieve and present a graphical representation 304b of the physical control panel 304a upon the contactless control panel user interface 306.

As shown, the graphical representations 302b, 304b may replicate a layout and functionality of each of the physical input means of the respective physical control panels 302a, 304a. The graphical representations 302b, 304b may include respective user interface inputs (e.g., graphical user interface input buttons, text boxes, and/or radio buttons) that may be configured to cause the processor 106 of the hardware 102 to execute functionality in the same manner as respective physical input means (e.g., touch input icons, keypad keys) of the physical control panels 302a, 304a. Stated differently, inputs to the user interface inputs of the graphical representations 302b, 304b by the user 124 are tantamount with respect to their functionality to touch inputs that would be provided to respective physical input means of the physical control panels 302a, 304a of the hardware 102. Accordingly, the contactless control application 110 may enable the user 124 to interact with the hardware 102 to complete one or more functions through the contactless control panel user interface 306 without having to physically touch any of the key pad keys and/or user interface input buttons of the physical control panels 302a, 304a.

As discussed, the hardware 102 may be configured in various formats. Accordingly, as shown in the illustrative example of FIG. 3B, the hardware 302 may be configured as an elevator that includes a physical control panel 308a configured as an elevator button panel that includes physical input means that are configured as elevator buttons that may be inputted to achieve respective elevator functions (e.g., traveling to a particular floor, opening/closing an elevator door). As shown, the physical input means of the physical control panel 308a may be presented as a graphical representation 308b upon the contactless control panel user interface 306. The graphical representation 308b may include touch input icons that may provide the same functionality as respective physical input means of the physical control panel 308a. Accordingly, the user 124 may interact with the hardware 102 to complete one or more functions of the elevator through the contactless control panel user interface 306 without physically touching any of the elevator buttons of the physical control panel 308a.

In some configurations, the contactless control application 110 may be configured to present details that are related to the functionality of the hardware 102 based on NFC communication of hardware data from the hardware 102 to the portable device 104. For example, as shown in FIG. 3B, the hardware 102 may be configured to communicate each floor that is reached and/or passed by the elevator and may communicate hardware data associated with the floor through NFC communication signals to the portable device 104. The contactless control application 110 may be configured to present a user interface graphic 310 upon the contactless control panel user interface 306 that may present the respective floor(s). This functionality may further allow the user 124 to utilize the portable device 104 as a remote command input means and data output means that is associated with the hardware 102.

Referring again to FIG. 1, the components of the hardware 102 may be operably controlled by a processor 118 of the hardware 102. The processor 118 may include its own memory (not shown), a disk (not shown), and an input/output (I/O) interface (not shown), which are each operably connected for computer communication via a bus (not shown). The I/O interface provides software and hardware to facilitate data input and output between the components of the hardware 102 and other components, networks, and data sources, of the system 100.

In one embodiment, the processor 118 may execute one or more operating systems, applications, and/or interfaces that are associated with the hardware 102 and may be associated with one or more physical control panels and associated physical inputs buttons and/or touch input icon buttons of the hardware 102. In one configuration, the processor 118 may execute a particular type of software and/or version of software that may be executed to perform one or more functions of the hardware 102. In some configurations, the processor 118 may also execute the contactless control application 110 to enable contactless control of the hardware 102 through NFC communication with the portable device 104.

In some configurations, the processor 118 may be in communication with one or more display units 120 of the hardware 102. The processor 118 may execute one or more instructions to present one or more graphical human machine interfaces that may be based on inputs received through the physical control panels and/or through the contactless control application 110 based on user inputs provided through the contactless control panel user interface. In some configurations, the one or more graphical human machine interfaces may be configured as physical control panels that include physical input means such as touch input icons that may be presented in a graphical format through the one or more display units 120 of the hardware 102 (as shown in FIG. 3A).

As discussed above, the QR code 108 may be configured as a physical QR code tag that is disposed upon the hardware 102 to be scanned by the user 124. Additionally or alternatively, the QR code 108 may be configured as a graphically generated QR code that is presented to the user 124 in a graphical manner through one or more of the display units 120. In one embodiment, the processor 118 may utilize the contactless control application 110 to execute a QR code generator (not shown) to generate and present the graphically generated QR code through the one or more display units 120 of the hardware 102. The portable device 104 may be used by the user 124 to scan the QR code 108 to utilize the contactless control application 110 to complete one or more functions the hardware 102.

As discussed above, during a process of completing an NFC connection between the portable device 104 and the hardware 102 based on the portable device 104 being placed within the predetermined proximity range of the NFC tag 116, the NFC handshake may occur between the hardware 102 and the portable device 104. Upon the occurrence of the NFC handshake, one or more graphical human machine interfaces may present an active NFC connection user interface icon through one or more display units 120 of the hardware 102 and/or through the portable device 104 to allow the user 124 to determine that there is an active communication of NFC signals between the portable device 104 and the hardware 102. In other words, the user 124 may be able to discern that the portable device 104 is located within the predetermined proximity range of the NFC tag 116 to enable the NFC communication between the portable device 104 and the hardware 102. In some embodiments, the one or more graphical human machine interfaces may present an icon that informs the user 124 that the graphical representations of the one or more respective graphical human machine interfaces being presented through the one or more display units 120 of the hardware 102 are being presented by the application 110 upon the contactless control panel user interface through the portable device 104.

In an exemplary embodiment, the processor 118 may be operably connected to a storage unit 122 of the hardware 102. The storage unit 122 may store one or more operating systems, applications, associated operating system data, application data, hardware system and subsystem user interface data, and the like that are executed by the processor 118 and one or more applications executed by the processor 118 including the contactless control application 110. In one embodiment, the storage unit 122 may store a hardware profile (not shown) that is associated with the hardware 102.

The hardware profile may include identifying information that pertains to the hardware 102. In one configuration, the hardware profile may include the version of the hardware 102. The version of the hardware 102 may include a make/model of the hardware 102, a model year of the hardware 102, a manufactures version of the hardware 102, a type and version of software that may be executed through the hardware 102. In one or more embodiments, the contactless control application 110 may be configured to access the storage unit 122 of the hardware 102 to retrieve the hardware profile to identify the hardware 102 that is associated with the QR code 108 as scanned by the portable device 104 to present the contactless control panel user interface that includes graphical representations of one or more physical control panels of the hardware 102.

In some embodiments, in addition to identifying information that pertain to the hardware 102, the hardware profile stored on the storage unit 122 may include control layout data that pertains to the functions of the type of hardware 102 and the functions of the physical input means of the one or more physical control panels of the hardware 102. For example, if the type of hardware 102 is an ATM, the control layout data may include data associated with the functions of the ATM, including, but not limited to, depositing funds, withdrawing funds, and the like. The control layout data may also include data associated with the functions of each of the physical input means of the one or more physical control panels of the ATM such as alpha-numeric inputs, enter input, cancel input, language selection input, and the like.

In some configurations, the contactless control application 110 may be configured to access the storage unit 122 of the hardware 102 to analyze the hardware profile to identify the hardware 102 and to retrieve the control layout data that pertains to the functions of the type of hardware 102. As discussed below, in one embodiment, the contactless control application 110 may be configured to retrieve the control layout data and present the contactless control panel user interface as a default layout that is associated with the type of hardware 102. In particular, the contactless control panel user interface may be presented as a default layout that is associated with the type of hardware 102 (e.g., ATM, elevator, kiosk). As discussed below, the default layout may be presented in a grid format that may be presented with one or more graphic widgets that may be associated with the functions of the type of hardware 102 and/or the physical input means of the one or more physical control panels of the hardware 102.

In an exemplary embodiment, the processor 118 may be operably connected to the NFC transceiver 114 of the hardware 102. As discussed, the NFC transceiver 114 may be operably connected to and associated with the NFC tag 116 that is associated with the hardware 102. In one configuration, the NFC transceiver 114 may be utilized to initiate one or more NFC connections between the hardware 102 and the portable device 104 to complete the NFC handshake that occurs between the NFC transceiver 114 of the hardware 102 and the NFC transceiver 112 of the portable device 104. As discussed below, the NFC handshake may allow the hardware 102 to complete NFC communication with the portable device 104 through NFC communication of data between the NFC transceiver 112 of the portable device 104 and the NFC transceiver 114 of the hardware 102. The bi-directional NFC communication between the NFC transceiver 112 and the NFC transceiver 114 of may be utilized to enable the user 124 to provide contactless inputs that are received and registered by the processor 106 of the hardware 102 and the communication of hardware data to the user 124 that is associated with messages, status updates, and/or additional customized input requests that may be communicated from the hardware 102 to the portable device 104 to be presented through the contactless control panel user interface.

With particular reference to the portable device 104, the portable device 104 may be configured as a smart phone, a tablet device, a laptop, a hand-held reader, a gaming device and/or a smart wearable device (e.g., smart watch). The portable device 104 may be manufactured by various manufacturers and may be configured in a plurality of form factors, designs, and/or configurations. As discussed above, the processor 106 of the portable device 104 may be configured execute the contactless control application 110. The processor 106 may include a disk (not shown), and an input/output (I/O) interface (not shown), which are each operably connected for computer communication via a bus (not shown). The I/O interface provides software and hardware to facilitate data input and output between the components of the portable device 104 and other components, networks, and data sources, of the system 100. In one embodiment, the processor 106 may execute one or more operating systems, applications, and/or interfaces that are associated with the portable device 104. In one configuration, the processor 106 may execute a particular type of software and/or version of software that may be executed to execute one or more functions of the portable device 104.

In addition to executing the contactless control application 110, the processor 106 may execute one or more third-party applications that may be stored upon a storage unit 126 of the portable device 104. The third-party applications may be associated with one or more third-party institutions that may be associated with the hardware 102. The one or more third-party institutions may include, but may not be limited to institutions that own, maintain, and/or provide the hardware 102 to be utilized by the user 124 (e.g., and additional authorized/public users). For example, if the hardware 102 is configured as an ATM, the user 124 may utilize a third-party online banking application associated with a third-party institution bank that owns/operates the hardware 102 to gain account access to complete one or more functions associated with the user's bank account. In another example, if the hardware 102 is an elevator operated by a third-party institution corporation, the user 124 may utilize a third-party security application associated with a building security infrastructure of the corporation to gain security access to certain floors of a particular building.

In some configurations, the contactless control application 110 may be configured to access data associated with the one or more third-party applications to retrieve credential information (e.g., debit card information, security card information) to enable the application 110 to provide access to functions of the hardware 102 without requiring the user 124 to physically input user credentials (e.g., input an ATM card to the hardware 102, input a pin, scan a card upon the hardware 102) to the hardware 102. This functionality may enable the user 124 to fully access and complete functions of the hardware 102 through the use of the contactless control application 110 on the portable device 104. In other words, the application 110 may enable the user 124 to fully access and complete functions of the hardware 102 without any physical interaction between the user 124, objects being held by the user 124, and the hardware 102 itself.

In an exemplary embodiment, the processor 106 may also be operably connected to a storage unit 126 of the portable device 104. The storage unit 126 may store one or more operating systems, applications, associated operating system data, application data, hardware system and subsystem user interface data, and the like that are executed by the processor 106 and one or more applications executed by the processor 106 including the contactless control application 110 and one or more third-party applications.

In one embodiment, the storage unit 126 may store a profile repository 128 that includes a user profile that is associated with the user 124 of the contactless control application 110 and the hardware 102. In particular, during an initial usage of the contactless control application 110 to control operation of the hardware 102, the application 110 may present the user 124 with a user profile creation user interface (not shown) through the portable device 104. The user profile creation user interface may include fields that pertain to identifying information of the user 124 (e.g., name, address, phone number, etc.) The user profile creation interface may also include one or more fields that pertain to one or more security credentials that may be inputted by the user 124 that may enable the user 124 to access the hardware 102 and/or one or more functions of the hardware 102. For example, the one or more security credentials that may be inputted by the user 124 through the one or more fields may include an ATM card number, a PIN, and/or a security code that may allow the user 124 to access and utilize the functions of the hardware 102 configured as an ATM.

Upon the population of the fields of the user profile creation interface, the contactless control application 110 may be configured to populate the user profile upon the profile repository 128 stored on the storage unit 126. Accordingly, when the user 124 uses the contactless control application 110 to utilize one or more functions of the hardware 102, the application 110 may be utilized to provide access to functions of the hardware 102 without requiring the user 124 to input physical credentials. This functionality may enable the user 124 to fully access and utilize the functions of the hardware 102 through the use of the contactless control application 110 on the portable device 104 without physically inputting a card, a pin, user credentials, and the like. Accordingly, the application 110 may enable the user 124 to utilize the hardware 102 without any physical interaction between the user 124, objects being held by the user 124, and the hardware 102 itself.

In one embodiment, a camera system 134 of the portable device 104 may include one or more cameras (not shown) that are disposed at one or more portions of the portable device 104. The camera system 134 may be utilized to capture an image of the QR code 108 when the user 124 is located near (e.g., within 0-6 feet) the hardware 102 to scan the QR code 108. Upon the scanning of the QR code 108, the camera system 134 may communicate data pertaining to the scanned QR code to the contactless control application 110.

In an exemplary embodiment, the storage unit 126 of the portable device 104 may also be configured to store a QR code repository 130. The QR code repository 130 may include QR data that is associated with the QR code 108 and is used to identify the hardware 102. More specifically, the QR data is associated with the QR code 108 to enable the application 110 to identify that the user 124 has scanned the QR code 108 to utilize the contactless control application 110 to execute one or more respective functions of the hardware 102.

The QR data stored upon the QR code repository 130 may include data points that include image data that pertain to an image of the QR code 108. The QR data may additionally include an encrypted hardware identification data code that pertains to the identification of the hardware 102, the type of hardware 102 (e.g., ATM, elevator, kiosk), and the configurations of one or more physical control panels of the hardware 102. The hardware identification code may include a numeric/alpha-numeric code that matches a model number, serial number, and/or identification number associated with the hardware 102.

In one embodiment, the hardware identification code may pertain to a description of the types of physical input means that are included as part of the one or more physical control panels of the hardware 102 and their respective functionality with respect to the execution of one or more functions of the hardware 102. For example, the configurations of the one or more physical control panels of the hardware 102 may include a description of the keys of a key pad of the hardware 102 configured as an ATM and the respective functionality of each key (when inputted) as executed by the processor 118 of the hardware 102.

As discussed below, when the user 124 scans the QR code 108 using the portable device 104, the camera system 134 may be configured to communicate image data that is associated with the QR code 108. The application 110 may be configured to query the QR code repository 130 to retrieve QR data that includes data points that match the image data to identify the user's utilization of the application 110 to utilize one or more functions of the hardware 102 and to further decrypt the hardware identification data code. Accordingly, the user functionality of the application 110 to present the contactless control panel user interface to interact with the hardware 102 through the portable device 104 may be enabled based on the scanning of the QR code 108.

In one configuration, the QR code repository 130 may be populated based on data that is communicated to the portable device 104 from a web server 140 that is managed by one or more third-party organizations that own, operate, and/or maintain the hardware 102. The web server 140 may store the QR data that is associated with the QR code 108 that is disposed upon the hardware 102 and/or is electronically generated to be presented through one or more display units 120 of the hardware 102 based on data that is uploaded to the web server 140 by the one or more third-party institutions. The web server 140 may be configured to communicate the QR data to the portable device 104 to populate the QR code repository 130 with the QR data that includes data points that match image data of the QR code 108 and the encrypted hardware identification code.

In an exemplary embodiment, the storage unit 126 may additionally store a control panel user interface repository 132. The control panel user interface repository 132 may be populated with control panel graphical data that may include codified computer executable data (e.g., computer programming language data) that pertain to respective graphical formats of the contactless control panel user interface. The control panel graphical data may be executed to present one or more graphical representations to replicate the layout and functionality of one or more respective physical control panels of the hardware 102. In particular, the control panel graphical data may be executed to present the graphical representations that provide the layout of the one or more physical control panels of the hardware 102 and functionality of physical input means of the physical control panels.

In one embodiment, the control panel user interface repository 132 may be populated with the control panel graphical data that is associated (e.g., electronically linked) with the hardware identification code that is analyzed to identify the hardware 102. As discussed, the hardware identification code may include a numeric/alpha-numeric code that matches a model number, serial number, and/or identification number associated with the hardware 102. Additionally, the hardware identification code may pertain to a description of the types of physical input means that are included as part of the one or more physical control panels of the hardware 102 and their respective functionality with respect to the execution of one or more functions of the hardware 102.

The control panel user interface repository 132 may be populated with the control panel graphical data and the associated hardware identification code based on a communication of the data from the web server 140 to the portable device 104. In particular, the web server 140 may store control panel graphical data and the associated hardware identification code pertaining to the hardware 102 based on data that is uploaded to the web server 140 by one or more third-party institutions that own, maintain, and/or provide the hardware 102 to be utilized by the user 124. The web server 140 may be configured to communicate the control panel graphical data and the associated hardware identification code to the portable device 104 to populate the control panel user interface repository 132 to be utilized by the contactless control application 110 to present the contactless control panel user interface through the portable device 104.

In one configuration, upon retrieving the QR data and identifying the hardware 102 based on the hardware identification code encrypted within the QR data stored upon the QR code repository 130, the contactless control application 110 may be configured to access and query the control panel user interface repository 132 to retrieve control panel graphical data that is associated with the hardware identification code as decrypted from the QR data. Accordingly, the contactless control application 110 may be configured to retrieve the control panel graphical data that pertains to graphical representations of the particular configurations of the physical control panels of the hardware 102.

The contactless control application 110 may thereby present the contactless control panel user interface that includes graphical representations of the one or more physical control panels associated with the hardware 102 with user interface inputs that may be inputted by the user 124 to provide contactless inputs to the hardware 102 through the portable device 104. As discussed below, upon the presentation of the contactless control panel user interface, if the portable device 104 is located within the predetermined proximity range of the NFC tag 116 of the hardware 102, input data associated with one or more inputs provided by the user 124 to one or more user interface inputs of the contactless control panel user interface may be communicated through NFC communication signals from the NFC transceiver 112 of the portable device 104 to the NFC transceiver 114 of the hardware 102 to provide contactless inputs to the hardware 102.

In an exemplary embodiment, the processor 106 of the portable device 104 may additionally be operably connected to a communication system 136 of the portable device 104. The communication system 136 may include antennas and components that may be utilized for wired and wireless computer connections and communications via various protocols. The communication system 136 may be capable of providing a wireless system using various protocols including, but not limited to, IEEE 802.11, IEEE 802.15.1, Bluetooth®, a local area network (LAN), a wide area network (WAN), a point-to-point system, a circuit switching system, a packet switching system, a cellular network system (e.g., CDMA, GSM, LTE, 3G, 4G), a universal serial bus, and the like.

In one or more alternate embodiments, the communication system 136 may be utilized to communicate input data from the portable device 104 to the hardware 102 using one or more of the various wireless protocols (e.g., Bluetooth®, a local area network (LAN), a wide area network (WAN), a point-to-point system). Accordingly, input data associated with one or more inputs provided by the user 124 to one or more user interface inputs of the contactless control panel user interface may be communicated by the communication system 136 using one or more of the various wireless protocols to provide contactless inputs to the hardware 102. Similarly, hardware data may be communicated to the portable device 104 from the hardware 102 through one or more of the various wireless protocols to be presented through the portable device 104.

In an exemplary embodiment, the communication system 136 may be configured to wirelessly connect (e.g., through one or more of the aforementioned wireless network communication protocols) to an internet cloud (not shown) to send and receive communication signals to and from the web server 140. The communication signals may include, but may not be limited to, QR data, control panel graphical data and associated hardware identification codes, and/or additional application data that may be executed to update and/or enhance the functionality of the contactless control application 110.

In one embodiment, the web server 140 may be configured to communicate data through the internet cloud to be received by the communication system 136 of the portable device 104. In some alternate embodiments, the web server 140 may be configured to communicate data (e.g., software updates, firmware updates) through the internet cloud to be received by the hardware 102. As discussed, the web server 140 may be managed by one or more third-party organizations that own, operate, and/or maintain the hardware 102. The web server 140 may be periodically updated with various forms of data that are associated with the hardware 102 and one or more physical control panels of the hardware 102.

In some configurations, upon the updating of the web server 140, the web server 140 may be configured to communicate the updated data to the contactless control application 110. In one embodiment, if the hardware 102 is updated with a new QR code (e.g., a new QR code is disposed upon the hardware 102 and/or a new QR code is graphically generated by the processor 118), the web server 140 may be updated with QR data that includes the encrypted hardware identification code that identifies the hardware 102 associated with the new QR code. In one embodiment, upon updating of the web server 140, the QR data that pertains to the new QR code may be communicated to the contactless control application 110 to be stored upon the QR code repository 130 to enable the application 110 to identify the user's utilization of the application 110 to complete one or more functions of the hardware 102.

In some circumstances, one or more of the physical control panels of the hardware 102 may be updated and/or replaced by one or more third-party organizations. For example, if the hardware 102 is configured as an ATM, a keypad and a touch input user interface may be replaced and updated with a newer version keypad and touch input user interface. In such a circumstance, the one or more third-party organizations may update the web server 140 with control panel graphical data and the associated hardware identification code that pertain to the one or more updated physical control panel of the hardware 102. Upon updating of the web server 140, the control panel graphical data may be communicated to the contactless control application 110 to be stored upon the control panel user interface repository 132 to provide the user 124 with the contactless control panel user interface that includes updated graphical representations of the one or more updated physical control panels of the hardware 102. This functionality may ensure that the contactless control application 110 may present one or more graphical representations to replicate the layout and functionality of one or more respective physical control panels of the hardware 102 as they are updated and/or replaced.

### II. The Contactless Touch-Free Hardware Control Application and Methods Executed by the Application

The contactless control application 110 and its components will now be described in more detail according to an exemplary embodiment and with continued reference to FIG. 1. In one or more embodiments, the contactless control application 110 may be stored on the storage unit 126 of the portable device 104 and/or the storage unit 122 of the hardware 102 and may be executed by the processor 106 of the portable device 104 and/or the processor 118 of the hardware 102. In another embodiment, the contactless control application 110 may be stored on the web server 140 and may be accessed by the portable device 104 through the communication system 136 and/or by a wireless data communication with the hardware 102.

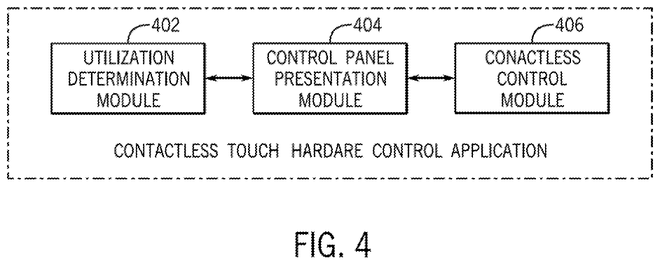

FIG. 4 is a schematic view of a plurality of modules 402-406 of the contactless control application 110 that may execute computer-implemented instructions for providing contactless control of the hardware 102 according to an exemplary embodiment of the present disclosure. In an exemplary embodiment, the plurality of modules 402-406 may include a utilization determination module 402, a control panel presentation module 404, and a contactless control module 406. It is appreciated that the contactless control application 110 may include one or more additional or alternative modules and/or sub-modules that are included in addition to or in lieu of the modules 402-406. Computer-implemented methods that are executed by the modules 402-406 for providing contactless control of the hardware 102 using NFC communication between the portable device 104 and the hardware 102 will now be described.

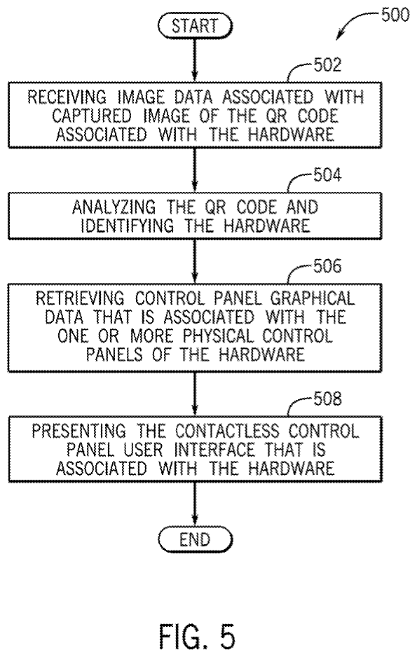

FIG. 5 is a process flow diagram of a method 500 for presenting the control panel user interface with a graphical representation of the one or more physical control panels of the hardware 102 according to an exemplary embodiment of the present disclosure. FIG. 5 will be described in reference to the components of FIG. 1 and FIG. 4, though it is to be appreciated that the method 500 may be used with additional and/or alternative system components. The method 500 may begin at block 502, wherein the method 500 may include receiving image data associated with a captured image of the QR code 108 associated with the hardware 102.

As discussed below, the QR code 108 associated with the hardware 102 may be disposed upon the hardware 102 and/or presented in a graphically generated format that is presented through one or more display units 120 of the hardware 102. In an exemplary embodiment, upon enabling the contactless control application 110, the utilization determination module 402 of the application 110 may be configured to present a user interface QR code scanning graphic prompt to the user 124 through the portable device 104. The user interface QR code scanning graphic prompt may direct the user 124 to capture an image of the QR code 108 associated with the hardware 102 to scan the QR code 108 to enable the contactless control application 110 to present the contactless control panel user interface that is associated with one or more physical control panels of the hardware 102.

In one embodiment, upon presenting the user interface QR code scanning graphic prompt, the utilization determination module 402 may be configured to communicate with the camera system 134 to receive image data associated with the QR code 108 scanned by the user 124 based on an image of the QR code 108 captured by the camera system 134. In particular, upon the user scanning the QR code 108 by utilizing the portable device 104 to capture the image of the QR code 108, the image data associated with the captured image of the QR code 108 may be communicated by the camera system 134 to the utilization determination module 402 to be analyzed.

The method 500 may proceed to block 504, wherein the method 500 may include analyzing the QR code 108 and identifying the hardware 102. In an exemplary embodiment, upon receiving the image data associated with the captured image of the QR code 108 from the camera system 134, the utilization determination module 402 may be configured to access the QR code repository 130 stored on the storage unit 126 of the portable device 104. As discussed above, the QR code repository 130 may store QR data that is associated with the QR code 108 to enable the application 110 to determine that the user 124 has scanned the QR code 108 to utilize the contactless control application 110 to execute one or more respective functions of the hardware 102.

In one embodiment, upon accessing the QR code repository 130, the utilization determination module 402 may be configured to query the QR code repository 130 for QR data that includes data points that match the image data to enable user functionality of the application 110 to interact with the hardware 102 through the portable device 104. Stated differently, the utilization determination module 402 may query the QR code repository 130 to retrieve QR data associated with the QR code 108 in order to recognize the QR code 108 that is associated with the hardware 102 has been scanned by the user 124 to utilize one or more functions of the hardware 102.

Upon retrieval of the QR data that includes data points that match the image data, the utilization determination module 402 may analyze the QR data to decrypt the encrypted hardware identification code to identify the hardware 102. As discussed, the hardware identification code may pertain to a description of the types of physical input means that are included as part of the one or more physical control panels of the hardware 102 and their respective functionality with respect to the execution of one or more functions of the hardware 102. In one embodiment, upon decrypting the hardware identification code, the utilization determination module 402 may be configured to identify the type of hardware 102 and may determine data associated with the one or more physical control panels of the hardware 102. The utilization determination module 402 may thereby communicate the decrypted hardware identification code to the control panel presentation module 404 of the contactless control application 110.

With continued reference to the method 500 of FIG. 5, the method 500 may proceed to block 506, wherein the method 500 may include retrieving control panel graphical data that is associated with the one or more physical control panels of the hardware 102. In an exemplary embodiment, upon receiving the decrypted hardware identification code communicated by the utilization determination module 402, the control panel presentation module 404 may be configured to access the control panel user interface repository 132 stored upon the storage unit 126 of the portable device 104. As discussed above, the control panel user interface repository 132 may store control panel graphical data that pertains to graphical representations of the particular configurations of the physical control panels of the hardware 102 as identified based on the hardware identification code that is associated with the control panel graphical data.

In one embodiment, the control panel presentation module 404 may be configured to query the control panel user interface repository 132 to retrieve control panel graphical data that is associated with a hardware identification code that matches the decrypted hardware identification code. Stated differently, the control panel presentation module 404 may query the control panel user interface repository 132 with the decrypted hardware identification code to retrieve control panel control panel graphical data that is associated with a matching hardware identification code. This functionality enables the retrieval of control panel graphical data that pertains to graphical representations of the particular configurations of the one or more physical control panels of the hardware 102.

In another embodiment, the control panel presentation module 404 may be configured to utilize the communication system 136 of the portable device 104 to communicate with the web server 140 through the internet cloud. In particular, the control panel presentation module 404 may be configured to utilize the communication system 136 to communicate the decrypted hardware identification code to the web server 140 to receive control panel graphical data that is associated with a matching hardware identification code. In one configuration, the web server 140 may communicate the control panel graphical data that pertains to graphical representations of the particular configurations of the physical control panels of the hardware 102 to the control panel presentation module 404 through wireless communications with the communication system 136 of the portable device 104.

The method 500 may proceed to block 508, wherein the method 500 may include presenting the contactless control panel user interface that is associated with the hardware 102. In an exemplary embodiment, upon retrieving/receiving the control panel graphical data that pertains to graphical representations of the particular configurations of the physical control panels of the hardware 102, the control panel presentation module 404 may be configured to execute the control panel graphical data.

The execution of the control panel graphical data may include providing computer-implemented instructions to the processor 106 of the portable device 104 to present the contactless control panel user interface that is associated with the hardware 102. As discussed above with respect to the illustrative examples of FIG. 3A and FIG. 3B, the control panel user interface may include one or more graphical representations of the one or more of the respective physical control panels of the hardware 102 based on the execution of the control panel graphical data. The one or more graphical representations presented upon the contactless control panel user interface may include user interface inputs that replicate a layout and a functionality of each of the physical input means of the respective physical control panels of the hardware 102.

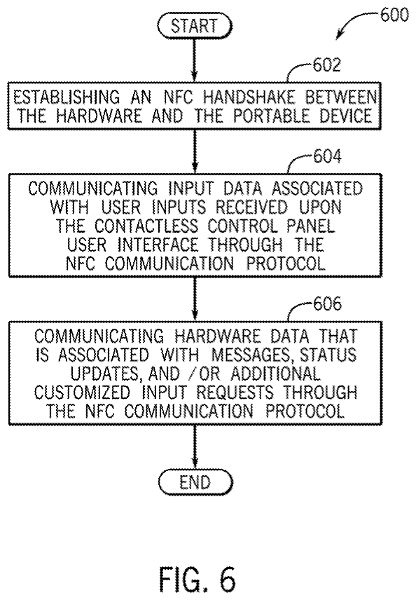

FIG. 6 is a process flow diagram of a method 600 for communicating input data and hardware data through the NFC communication protocol according to an exemplary embodiment of the present disclosure. FIG. 6 will be described in reference to the components of FIG. 1 and FIG. 4, though it is to be appreciated that the method 600 may be used with additional and/or alternative system components. The method 600 of FIG. 6 may begin at block 602, wherein the method 600 may include establishing an NFC handshake between the hardware 102 and the portable device 104.

In an exemplary embodiment, upon the execution of the control panel graphical data and presenting the contactless control panel user interface through the portable device 104, the control panel presentation module 404 may be configured to present an NFC initialization user interface graphic prompt to the user 124. The NFC initialization user interface graphic prompt may prompt the user 124 to place the portable device 104 within the predetermined proximity of the NFC tag 116. In one configuration, upon presentation of the NFC initialization user interface graphic prompt, the control panel presentation module 404 may be configured to communicate data pertaining to the presentation of the user interface prompt to the contactless control module 406 of the contactless control application 110.

In an exemplary embodiment, the contactless control module 406 may be configured to communicate with the NFC transceiver 112 of the portable device 104 to determine if the portable device 104 is placed within the predetermined proximity range of the NFC tag 116 associated with the hardware 102 based on a receipt of NFC signals that are transmitted by the NFC transceiver 112 of the portable device 104 to the NFC transceiver 114 of the hardware 102 that is operably connected to an NFC tag 116. Additionally or alternatively, upon presentation of the user interface prompt, the control panel presentation module 404 may be configured to communicate with the NFC transceiver 112 of the portable device 104 to determine if the portable device 104 is placed within the predetermined proximity range of the NFC tag 116 associated with the hardware 102 based on a receipt of NFC signals that are transmitted by the NFC transceiver 114 of the hardware 102 to the NFC transceiver 112 of the portable device 104.

In an exemplary embodiment, if it is determined that the portable device 104 is placed within the predetermined proximity range of the NFC tag 116 based on the receipt of NFC signals, the NFC transceiver 112 of the portable device 104 and the NFC transceiver 114 of the hardware 102 may establish the NFC handshake. As discussed above, the NFC handshake may occur to commence the exchange of NFC communication signals between the NFC transceiver 112 of the portable device 104 and the NFC transceiver 114 of the hardware 102.

The method 600 may proceed to block 604, wherein the method 600 may include communicating input data associated with user inputs received upon the contactless control panel user interface through the NFC communication protocol. In an exemplary embodiment, the contactless control module 406 may be configured to communicate with the control panel presentation module 404 to determine one or more inputs that may be provided by the user 124 to one or more user inputs of the contactless control panel user interface. In particular, when the user 124 utilizes the contactless control panel user interface to input one or more user inputs that graphically represent one or more respective physical input means of one or more physical control panels of the hardware 102, the control panel presentation module 404 may communicate respective input data to the contactless control module 406. The contactless control module 406 may thereby determine the one or more inputs that may be provided by the user 124.

In an exemplary embodiment, the contactless control module 406 may utilize the NFC transceiver 112 of the portable device 104 to communicate the input data through NFC communication signals to be received by the NFC transceiver 114 of the hardware 102. In one configuration, during the communication of NFC communication signals, the control panel presentation module 404 may present a NFC active communication user interface graphic prompt through the portable device 104. The NFC active communication user interface graphic prompt may prompt the user 124 to continue to place the portable device 104 within the predetermined proximity range of the NFC tag 116 to continue the bi-directional NFC communication between the NFC transceiver 112 of the portable device 104 and the NFC transceiver 114 of the hardware 102. Accordingly, as the portable device 104 continues to be placed within the predetermined proximity range of the NFC tag 116, the NFC transceiver 112 of the portable device 104 communicates the input data through NFC communication signals that may be received by the hardware 102 through the NFC transceiver 114.

In one embodiment, upon the receipt of input data through the NFC communication signals that are received through the NFC transceiver 114 of the hardware 102, the NFC transceiver 114 may be configured to communicate the input data to the processor 118 of the hardware 102. The processor 118 may be configured to operably control the functionality of one or more components of the hardware 102 to complete respective functions of the hardware 102 based on the received contactless inputs provided by the user 124 through the contactless control panel user interface provided on the portable device 104.

With continued reference to FIG. 6, the method 600 may proceed to block 606, wherein the method 600 may include communicating hardware data that is associated with messages, status updates, and/or additional customized input requests through the NFC communication protocol. In one embodiment, the hardware 102 may be configured to communicate hardware data to be communicated to the user 124 through the contactless control application 110.

In particular, the hardware 102 may be configured to utilize the contactless control application 110 to communicate messages, status updates, and/or additional customized input requests to the user 124 through the contactless control panel user interface on the portable device 104. In one configuration, the contactless control module 406 may be configured to utilize the NFC transceiver 114 of the hardware 102 to communicate the input data through NFC communication signals to be received by the NFC transceiver 112 of the portable device 104. Accordingly, as the portable device 104 continues to be placed within the predetermined proximity range of the NFC tag 116, the NFC transceiver 112 of the portable device 104 may receive the hardware data communicated through NFC communication signals that may be transmitted by the NFC transceiver 114 of the hardware 102.

As discussed above, the profile repository 128 stored upon the storage unit 126 of the portable device 104 may store the user profile that is associated with the user 124. In one embodiment, if the user 124 is presented with messages, status updates, and/or additional customized input requests to the user 124 that request the user 124 to input credentials, the contactless control module 406 may be configured to access the user credentials from the user profile stored upon the profile repository 128 to be communicated to the hardware 102 through the NFC communication signals between the NFC transceivers 112, 114. Accordingly, the contactless control application 110 may enable the user 124 to utilize the hardware 102 without any physical interaction between the user 124, objects being held by the user 124, and the hardware 102 itself.

It is to be appreciated that as the portable device 104 is placed within the predetermined proximity range of the NFC tag 116, bi-directional NFC communication may be continually utilized to communicate input data, hardware data, user credentials, and additional data points between the portable device 104 and the hardware 102 to enable the hardware 102 to provide one or more functions to the user 124. Accordingly, the user 124 may utilize the portable device 104 to provide inputs to the hardware 102 to enable the hardware 102 to perform one or more functions and to receive data associated with one or more functions of the hardware 102 without requiring the user 124 to physically touch input the physical input means of the one or more physical control panels of the hardware 102.

In one or more embodiments, during the bi-directional NFC communication between the portable device 104 and the hardware 102, the contactless control module 406 may communicate with the NFC transceiver 112 to determine when the portable device 104 is no longer placed within the predetermined proximity of the hardware 102. If it is determined that the portable device 104 is no longer placed within the predetermined proximity of the hardware 102, the contactless control module 406 may communicate respective data to the control panel presentation module 404. The control panel presentation module 404 may thereby present a contactless session end conformation user interface input upon the contactless control unit user interface that may enable the user 124 to actively end an active contactless control session between the portable device 104 and the hardware 102. Accordingly, if the user 124 inputs the contactless session end conformation user interface input, the contactless control module 406 may thereby cease presentation of the contactless control panel user interface through the portable device 104 and may thereby end contactless control of the hardware 102.

In an alternate embodiment, it is determined that the portable device 104 is no longer placed within the predetermined proximity of the hardware 102, the contactless control module 406 may initiate a session discontinuation timer. The session discontinuation may be configured as a timer that is implemented for a predetermined period of time (e.g., 3 minutes) to be used to end the active contactless control session between the portable device 104 and the hardware 102. In other words, the session discontinuation timer may be utilized as a period of time in which the NFC communication between the portable device 104 and the hardware 102 is no longer established based on discontinuation of the placement of the portable device 104 within the predetermined proximity range of the NFC tag 116. Accordingly, if the session disconsolation timer expires, the contactless control module 406 may thereby cease presentation of the contactless control panel user interface through the portable device 104 and may thereby end contactless control of the hardware 102.

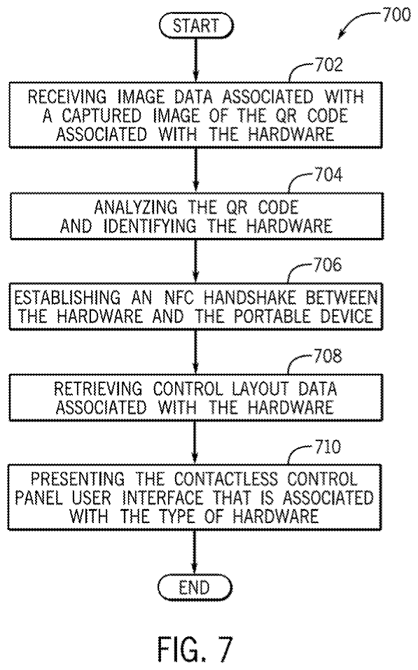

FIG. 7 is a process flow diagram of a method 700 for providing a contactless control panel user interface that is associated with the type of hardware 102 according to an exemplary embodiment of the present disclosure. FIG. 7 will be described in reference to the components of FIG. 1 and FIG. 4, though it is to be appreciated that the method 700 may be used with additional and/or alternative system components. The method 700 may begin at block 702, wherein the method 700 may include receiving image data associated with a captured image of the QR code 108 associated with the hardware 102.

As discussed, the QR code 108 associated with the hardware 102 may be disposed upon the hardware 102 and/or presented in a graphically generated format that is presented through one or more display units 120 of the hardware 102. Upon enabling the contactless control application 110, the utilization determination module 402 of the application 110 may be configured to present a user interface QR code scanning graphic prompt to the user 124 through the portable device 104.

In one embodiment, upon presenting the user interface QR code scanning graphic prompt, the utilization determination module 402 may be configured to communicate with the camera system 134 to receive image data associated with the QR code 108 scanned by the user 124 based on an image of the QR code 108 captured by the camera system 134. In particular, upon the user scanning the QR code 108 by utilizing the portable device 104 to capture the image of the QR code 108, the image data associated with the captured image of the QR code 108 may be communicated by the camera system 134 to the utilization determination module 402 to be analyzed.

The method 700 may proceed to block 704, wherein the method 700 may include analyzing the QR code 108 and identifying the hardware 102. In an one embodiment, upon receiving the image data associated with the captured image of the QR code 108 from the camera system 134, the utilization determination module 402 may be configured to access the QR code repository 130 stored on the storage unit 126 of the portable device 104. In one embodiment, upon accessing the QR code repository 130, the utilization determination module 402 may query the QR code repository 130 to retrieve QR data associated with the QR code 108 in order to recognize the QR code 108 that is associated with the hardware 102 has been scanned by the user 124 to utilize one or more functions of the hardware 102.

Upon retrieval of the QR data, the utilization determination module 402 may analyze the QR data to decrypt the encrypted hardware identification code to identify the hardware 102. In one embodiment, the hardware identification code may pertain to a description of the type of hardware 102 (e.g., ATM, elevator, kiosk). In one embodiment, upon decrypting the hardware identification code, the utilization determination module 402 may be configured to identify the type of hardware 102. Upon identifying the type of hardware 102, based on the QR data associated with the captured QR code 108, the utilization determination module 402 may be configured to communicate the type of hardware 102 to the control panel presentation module 404 of the contactless control application 110.

The method 700 may proceed to block 706, wherein the method 700 may include establishing an NFC handshake between the hardware 102 and the portable device 104. In one embodiment, upon determining the type of hardware 102, the control panel presentation module 404 may be configured to present the NFC initialization user interface graphic prompt to the user 124. In one configuration, upon presentation of the NFC initialization user interface graphic prompt, the control panel presentation module 404 may be configured to communicate data pertaining to the presentation of the user interface prompt to the contactless control module 406 of the contactless control application 110.

The contactless control module 406 may be configured to communicate with the NFC transceiver 112 of the portable device 104 to determine if the portable device 104 is placed within the predetermined proximity range of the NFC tag 116 associated with the hardware 102. Additionally or alternatively, upon presentation of the user interface prompt, the control panel presentation module 404 may be configured to communicate with the NFC transceiver 112 of the portable device 104 to determine if the portable device 104 is placed within the predetermined proximity range of the NFC tag 116 associated with the hardware 102 based on a receipt of NFC signals that are transmitted by the NFC transceiver 114 of the hardware 102 to the NFC transceiver 112 of the portable device 104.

In an exemplary embodiment, if it is determined that the portable device 104 is placed within the predetermined proximity range of the NFC tag 116 based on the receipt of NFC signals, the NFC transceiver 112 of the portable device 104 and the NFC transceiver 114 of the hardware 102 may establish the NFC handshake. In one embodiment, the NFC handshake may occur to commence the exchange of NFC communication signals between the NFC transceiver 112 of the portable device 104 and the NFC transceiver 114 of the hardware 102.

With continued reference to FIG. 7, the method 700 may proceed to block 708, wherein the method 700 may include retrieving control layout data associated with the hardware 102. In an exemplary embodiment, upon establishing the NFC handshake to commence the exchange of NFC communication signals between the NFC transceiver 112 of the portable device 104 and the NFC transceiver 114 of the hardware 102, the control panel presentation module 404 may be configured to access the hardware profile associated with the hardware 102 and stored upon the storage unit 122 to retrieve control layout data stored upon the hardware profile. As discussed above, the hardware profile stored on the storage unit 122 may include control layout data that pertains to the functions of the type of hardware 102 and the functions of the physical input means of the one or more physical control panels of the hardware 102.

In one embodiment, upon retrieving the control layout data, the control panel presentation module 404 may be configured to utilize the NFC transceiver 114 of the hardware 102 to communicate the control layout data through NFC communication signals to the NFC transceiver 112 of the portable device 104. In other words, the control panel presentation module 404 may be configured to communicate the control layout data from the hardware 102 to the portable device 104 through NFC communication.

The method 700 may proceed to block 710, wherein the method 700 may include presenting the contactless control panel user interface that is associated with the type of hardware 102. In an exemplary embodiment, upon communication of the control layout data from the hardware 102 to the portable device 104 through NFC communication, the control panel presentation module 404 may be configured to analyze the control layout data to determine the functions of the type of hardware 102 and the functions of physical input means of the one or more physical control panels of the hardware 102.

In one configuration, the control panel presentation module 404 may be configured to present the contactless control panel user interface that is associated with the type of hardware 102. The contactless control panel user interface may be presented as a default layout that is associated with the type of hardware 102 (e.g., ATM, elevator, kiosk). The default layout may be presented in a grid format (e.g., gridded configuration) that may be presented with one or more graphic widgets that may be associated with the functions of the type of hardware 102 and/or the physical input means of the one or more physical control panels of the hardware 102. In one configuration, the presentation of the default layout that is associated with the type of hardware 102 is not based on control panel graphical data that is retrieved from the control panel user interface repository 132 and that pertains to graphical representations of the particular configurations of the physical control panels of the hardware 102. Rather, the presentation of the default layout is presented in a default grid format that may be populated with one or more widgets that replicate the functions of the type of hardware 102 (e.g., deposit, withdraw) and one or more physical input means of the hardware 102 (e.g., select language, cancel, accept).

In one embodiment, the contactless control module 406 may be configured to communicate with the control panel presentation module 404 to determine one or more inputs that may be provided by the user 124 through one or more widgets of the default layout of the contactless control panel user interface. In particular, when the user 124 utilizes the contactless control panel user interface to input one or more widgets that are provided in a grid format, the control panel presentation module 404 may communicate respective input data to the contactless control module 406. The contactless control module 406 may thereby determine the one or more inputs that may be provided by the user 124.

As one or more inputs are received, the control panel presentation module 404 may be configured to access and retrieve control layout data that pertains to one or more additional functions of the type of hardware 102 and/or the one or more physical input means of the hardware 102 that may pertain to the type of input received. Accordingly, the control panel presentation module 404 may be configured to utilize the NFC transceiver 112 to communicate the control layout data through NFC communication to the portable device 104 to thereby present one or more additional default layouts of the contactless control panel user interface. For example, if the user 124 selects a widget that is associated with a deposit of funds of a hardware 102 configured as an ATM, the control panel presentation module 404 may be configured to access and retrieve control layout data that pertains to selection of an amount of funds and/or a funding account that may be presented upon the contactless control panel user interface presented through the portable device 104.

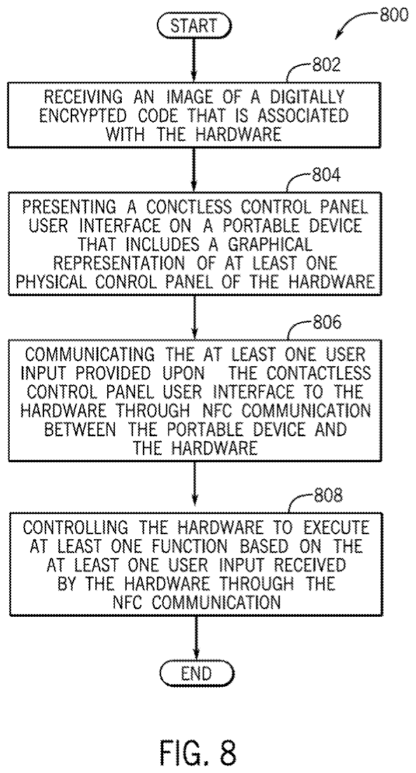

FIG. 8 is a process flow diagram of a method 800 for providing contactless control of hardware 102 according to an exemplary embodiment of the present disclosure. FIG. 8 will be described in reference to the components of FIG. 1 and FIG. 4, though it is to be appreciated that the method 800 may be used with additional and/or alternative system components. The method 800 may begin at block 802, wherein the method 800 may include receiving an image of a digitally encrypted code that is associated with the hardware 102.

The method 800 may proceed to block 804, wherein the method 800 may include presenting a contactless control panel user interface on a portable device 104 that includes a graphical representation of at least one physical control panel of the hardware 102. The method 800 may proceed to block 806, wherein the method 800 may include communicating the at least one user input provided upon the contactless control panel user interface to the hardware 102 through NFC communication between the portable device 104 and the hardware 102. The method 800 may proceed to block 808, wherein the method 800 may include controlling the hardware 102 to execute at least one function based on the at least one user input received by the hardware 102 through the NFC communication.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for providing contactless control of hardware comprising:
receiving an image of a digitally encrypted code that is associated with the hardware;
presenting a contactless control panel user interface on a portable device that includes a graphical representation of at least one physical control panel of the hardware, wherein the contactless control panel user interface enables at least one input to be provided to the hardware without physical user contact with the at least one physical control panel of the hardware;
communicating the at least one user input provided upon the contactless control panel user interface to the hardware through near field communication (NFC communication) between the portable device and the hardware; and
controlling the hardware to execute at least one function based on the at least one user input received by the hardware through the NFC communication.

2. The computer-implemented method of claim 1, wherein the digitally encrypted code includes a quick response code (QR code) that is scanned by the portable device based on capturing of the image of the digitally encrypted code, wherein the QR code is disposed upon the hardware or graphically generated to be presented through at least one display unit of the hardware.

3. The computer-implemented method of claim 2, further including accessing and querying a QR code repository stored on the portable device to determine QR code data that is associated with the QR code, wherein the QR code data includes image data that pertains to the image of the digitally encrypted code that is associated with the hardware and an encrypted hardware identification code that pertains to an identification of the at least one physical control panel of the hardware.

4. The computer-implemented method of claim 3, wherein presenting the contactless control panel user interface on the portable device includes accessing and querying a control panel user interface repository stored on the portable device to retrieve control panel graphical data that is associated with the at least one physical control panel of the hardware.

5. The computer-implemented method of claim 4, wherein presenting the contactless control panel user interface on the portable device includes querying the control panel user interface repository to retrieve the control panel graphical data that is associated with a hardware identification code that matches the encrypted hardware identification code included within the digitally encrypted code.

6. The computer-implemented method of claim 5, wherein presenting the contactless control panel user interface on the portable device includes executing the control panel graphical data that is retrieved from the control panel user interface repository, wherein the graphical representation of at least one physical control panel of the hardware includes at least one touch input that provides a functionality of at least one respective physical input means of the at least one physical control panel of the hardware.

7. The computer-implemented method of claim 6, wherein communicating the at least one user input provided upon the contactless control panel user interface includes determining that the portable device is placed within a predetermined proximity range of an NFC tag that is disposed upon the hardware and is operably connected to a NFC transceiver of the hardware, wherein an NFC handshake is established between the NFC transceiver of the hardware and the NFC transceiver of the hardware.

8. The computer-implemented method of claim 7, wherein receiving input data associated with an input of the at least one touch input provided through the contactless control panel user interface includes receiving the input to the at least one touch input presented upon the graphical representation of at least one physical control panel of the hardware, wherein the input data is communicated to the hardware though NFC communication between the NFC transceiver of the portable device and the NFC transceiver of the hardware upon the establishment of the NFC handshake.

9. The computer-implemented method of claim 8, wherein controlling the hardware includes receiving the input data through the NFC communication, wherein the NFC transceiver of the hardware communicates the input data to a processor of the hardware to execute the at least one function based on the at least one user input received by the hardware, wherein the hardware includes at least one of: an automated teller machine, an elevator, a kiosk, and a cross-walk lighting switch.

10. A system for providing contactless control of hardware comprising:
a memory storing instructions when executed by a processor cause the processor to:
receive an image of a digitally encrypted code that is associated with the hardware;
present a contactless control panel user interface on a portable device that includes a graphical representation of at least one physical control panel of the hardware, wherein the contactless control panel user interface enables at least one input to be provided to the hardware without physical user contact with the at least one physical control panel of the hardware;
communicate the at least one user input provided upon the contactless control panel user interface to the hardware through near field communication (NFC communication) between the portable device and the hardware; and
control the hardware to execute at least one function based on the at least one user input received by the hardware through the NFC communication.

11. The system of claim 10, wherein the digitally encrypted code includes a quick response code (QR code) that is scanned by the portable device based on capturing of the image of the digitally encrypted code, wherein the QR code is disposed upon the hardware or graphically generated to be presented through at least one display unit of the hardware.

12. The system of claim 11, further including accessing and querying a QR code repository stored on the portable device to determine QR code data that is associated with the QR code, wherein the QR code data includes image data that pertains to the image of the digitally encrypted code that is associated with the hardware and an encrypted hardware identification code that pertains to an identification of the at least one physical control panel of the hardware.

13. The system of claim 12, wherein presenting the contactless control panel user interface on the portable device includes accessing and querying a control panel user interface repository stored on the portable device to retrieve control panel graphical data that is associated with the at least one physical control panel of the hardware.

14. The system of claim 13, wherein presenting the contactless control panel user interface on the portable device includes querying the control panel user interface repository to retrieve the control panel graphical data that is associated with a hardware identification code that matches the encrypted hardware identification code included within the digitally encrypted code.

15. The system of claim 14, wherein presenting the contactless control panel user interface on the portable device includes executing the control panel graphical data that is retrieved from the control panel user interface repository, wherein the graphical representation of at least one physical control panel of the hardware includes at least one touch input that provides a functionality of at least one respective physical input means of the at least one physical control panel of the hardware.

16. The system of claim 15, wherein communicating the at least one user input provided upon the contactless control panel user interface includes determining that the portable device is placed within a predetermined proximity range of an NFC tag that is disposed upon the hardware and is operably connected to a NFC transceiver of the hardware, wherein an NFC handshake is established between the NFC transceiver of the hardware and the NFC transceiver of the hardware.

17. The system of claim 16, wherein receiving input data associated with an input of the at least one touch input provided through the contactless control panel user interface includes receiving the input to the at least one touch input presented upon the graphical representation of at least one physical control panel of the hardware, wherein the input data is communicated to the hardware though NFC communication between the NFC transceiver of the portable device and the NFC transceiver of the hardware upon the establishment of the NFC handshake.

18. The system of claim 17, wherein controlling the hardware includes receiving the input data through the NFC communication, wherein the NFC transceiver of the hardware communicates the input data to a processor of the hardware to execute the at least one function based on the at least one user input received by the hardware, wherein the hardware includes at least one of: an automated teller machine, an elevator, a kiosk, and a cross-walk lighting switch.

19. A non-transitory computer readable storage medium storing instructions that when executed by a computer, which includes a processor performs a method, the method comprising:
receiving an image of a digitally encrypted code that is associated with hardware;
presenting a contactless control panel user interface on a portable device that includes a graphical representation of at least one physical control panel of the hardware, wherein the contactless control panel user interface enables at least one input to be provided to the hardware without physical user contact with the at least one physical control panel of the hardware;
communicating the at least one user input provided upon the contactless control panel user interface to the hardware through near field communication (NFC communication) between the portable device and the hardware; and
controlling the hardware to execute at least one function based on the at least one user input received by the hardware through the NFC communication.

20. The non-transitory computer readable storage medium of claim 19, wherein controlling the hardware includes receiving input data through the NFC communication, wherein a NFC transceiver of the hardware communicates the input data to a processor of the hardware to execute the at least one function based on the at least one user input received by the hardware, wherein the hardware includes at least one of: an automated teller machine, an elevator, a kiosk, and a cross-walk lighting switch.
